(19) United States
(12) Patent Application Publication
(10) Pub. No.: US 2012/0037604 A1
(43) Pub. Date: Feb. 16, 2012

(54) LASER BEAM MACHINING DEVICE

(76) Inventor: Katsuya Shikata, Aichi (JP)

(21) Appl. No.: 13/260,733

(22) PCT Filed: Mar. 31, 2009
(86) PCT No.: PCT/JP2009/056614

§ 371 Date: Sep. 28, 2011

(51) Int. Cl. B23K 26/38

(52) U.S. Cl. 219/121.67

(57) ABSTRACT

Provided is a laser beam machining apparatus (1) which enables prevention of a reduction in the transmittance of a protection glass (32) caused by adhesion of high-temperature foreign substances such as spatters and fumes generated in laser beam machining to thereby increase the useful life of the protection glass (32). The laser beam machining apparatus (1) performs machining by melting the surface of a workpiece (2) by irradiating the surface of the workpiece (2) with a laser beam. The laser machining apparatus is provided with a condenser lens (31) for condensing the laser beam onto the surface of the workpiece (2), the protection glass (32) for protecting the condenser lens (31), which is disposed on the workpiece (2) side of the condenser lens (31), a torch (34) for emitting the laser beam, which is disposed facing the workpiece (2), and an assist gas feeding unit (40) (cooling means) for cooling the protection glass (32).

### TECHNICAL FIELD

The present invention relates to a laser machining apparatus.

### BACKGROUND ART

There is a laser machining apparatus broadly used for laser beam machining such as laser cutting or laser welding by emitting a laser beam to a workpiece.

For instance, the conventional laser machining apparatus includes a laser oscillator, a transmitting path and a machining head, in which the laser oscillator generates a laser beam, the laser beam is transmitted through the transmitting path and the machining head emits the laser beam to the workpiece, thereby melting the surface of the workpiece.

FIG. 18 illustrates such machining head 100 containing a condenser lens 110, a protection glass 120, a lens housing 130 and a torch 140.

The condenser lens 110 focuses the laser beam generated by the laser oscillator and condenses the energy thereof. The protection glass 120 prevents metal foreign matters 150, such as high temperature spatters and fumes, from attaching to the condenser lens 110.

The lens housing 130 houses the condenser lens 110 and the protection glass 120, and protects these optical systems. The torch 140 is disposed at the tip of the machining head 100, prevents the laser beam focused through the condenser lens 110 from dispersing and avoids the external influences on the laser beam.

In the above-described machining head 100, the laser beam focused through the condenser lens 110 in the lens housing 130 is emitted to the workpiece out of the torch 140 passing through the protection glass 120.

To maintain the stability of welding quality with preventing the oxidation of the surface of the workpiece and the penetration of the foreign matter, there is a common method of blowing the assist gas such as nitrogen or argon gas to the surface of the workpiece so as to generate inert atmosphere around the welding spot.

As to the machining head 100 illustrated in FIG. 18, when the foreign matters 150 enter into the torch 140 through the opening of the torch 140 and directly reach the protection glass 120 or indirectly get to the glass 120 reflecting on the inner surface of the torch 140, and then the foreign matters adhere to the protection glass 120. Further, if the temperature of the foreign matter is higher than the melting point of the protection glass, the foreign matter may penetrate into the glass and strongly adhere to the surface of the protection glass 120. In such case, the surface of the protection glass 120 is degraded and damaged.

As a result, the transmittance of the protection glass 120 is reduced, so that the laser output is lowered and the machining quality is deteriorated. In order to keep the laser output, the protection glass 120 is required to be changed frequently, but it costs too much.

The machining head disclosed in JP H11-245077 A proposes a solution to solve above-mentioned problem. The torch of the machining head is formed with a spiral passage for the assist gas at the inside thereof. Due to this structure, the assist gas blows along the spiral passage to the machining point, thereby preventing the high temperature foreign matters from entering into the machining head.

Unfortunately, the machining head disclosed in JP H11-24507 A cannot avoid an approach of the spatter moving faster than the blowing speed of the assist gas. Therefore, there remains the problem that the adhesion to the protection glass and penetration (welding) thereinto of the foreign matters having higher temperature than the melting point of the protection glass, such as the spatter that is higher temperature than the melting point of the workpiece. Especially, in the case that the torch is close to the workpiece, the opening area of the torch where the spatters are enterable is relatively large, so that it is difficult to prevent the entry of the spatters.

When using the laser machining apparatus to weld the workpiece, the assist gas should be blown gently to generate inert atmosphere in the welding spot.

Thus, the machining head of JP H11-245077 A does not work well, because the blowing speed of the assist gas should be increased to prevent the foreign matters of high temperature from entering into the torch, which makes the quality of welding lowered.

### CITATION LIST

### Patent Literature

PTL 1: JP H11-245077 A

### SUMMARY OF INVENTION

### Technical Problem

The objective of the present invention is to provide an unexpected laser machining apparatus capable of preventing the reduction of transmittance of the protection glass caused by the adhesion of the foreign matters of high temperature such as the spatters and fumes generated in the laser machining, thereby enhancing the lifetime of the protection glass.

### Technical Solution

A laser machining apparatus according to the present invention is a laser machining apparatus that emits a laser beam to the surface of a workpiece to melt the surface, thereby performing a laser beam machining. The one embodiment of the present invention includes a condenser lens for focusing the laser beam to the surface of the workpiece; a protection glass disposed nearer to the workpiece than to the condenser lens, protecting the condenser lens; a torch disposed facing the workpiece, emitting the laser beam; and cooling means for cooling the protection glass.

In the preferable embodiment, the cooling means blows a cooling gas to the protection glass to cool the protection glass and the atmosphere in the torch.

Advantageously, the cooling gas is an assist gas blown to the surface of the workpiece during the laser machining to form an inert atmosphere around the surface of the workpiece.

It is preferable that the cooling means includes multiple openings for blowing the assist gas, and the assist gas is blown to the surface of the protection glass from the blowing openings.

Preferably, the multiple openings are disposed facing the inside of the torch and spaced each other in the inner circumference of the torch.

In the alternative embodiment of the present invention, the laser machining apparatus further includes an exhausting means for exhausting the atmosphere in the torch to the outside thereof.

The exhausting means preferably includes an exhausting opening through which the atmosphere in the torch is exhausted, and adjusting means for adjusting the flow amount of the atmosphere to be exhausted.

In the advantageous embodiment of the present invention, the inner surface of the torch is formed in a multi-step surface.

The multi-step surface advantageously includes a face opposing to the surface of the workpiece, and the face opposing to the surface of the workpiece is formed such that a line reflected on the face, that is a radially incident line from the surface of the workpiece, does not direct the protection glass.

Furthermore, the multi-step surface of the torch is configured by multiple grooves formed depressed from the inner surface to the outer surface of the torch and formed continuously from the base end to the tip end of the torch.

In the other embodiment of the present invention, the tip end of the torch is provided with a tip extended toward the surface of the workpiece, and the opening area of the tip is set smaller than that of the torch.

Preferably, the inner surface of the tip is configured continuously from the inner surface of the torch.

Advantageously, the tip is separated from the torch.

### Advantageous Effects of Invention

According to the embodiment of the present invention, a laser machining apparatus is provided that is capable of preventing the reduction of transmittance of the protection glass caused by the adhesion of the foreign matters of high temperature such as the spatters and fumes generated in the laser machining, thereby enhancing the lifetime of the protection glass.

### BRIEF DESCRIPTION OF DRAWINGS

FIG. 1 schematically illustrates a laser machining apparatus.

FIG. 2 is a section view of a machining head.

FIG. 3 depicts a cooling means of the laser machining apparatus.

FIG. 4 shows a flow of an assist gas in a torch.

FIG. 5 is an A-A section view of the FIG. 4, showing an arrangement of the cooling means.

FIG. 6 illustrates a feeding passage of the assist gas.

FIG. 7 depicts an exhausting means of the laser machining apparatus.

FIG. 8 shows an alternative embodiment of the exhausting means of the laser machining apparatus.

FIG. 9 depicts a multi-step surface formed in the inner surface of the torch.

FIG. 10 is an enlarged view of the multi-step surface.

FIG. 11 shows an alternative embodiment of the multi-step surface.

FIG. 12 shows another embodiment of the multi-step surface.

FIG. 13 depicts a tip of the laser machining apparatus and is a B-B section view of FIG. 14.

FIG. 14 is a section view of the tip.

FIG. 15 is C-C section view of FIG. 14 showing the opening of the tip.

FIG. 16 shows comparison between the opening areas of the tip and that of the torch, (a) is a tip end of the torch, and (b) is an E-E section view of the FIG. 15 showing the tip end of the tip.

FIG. 17 shows the flow of assist gas around the tip end of the machining head.

FIG. 18 schematically illustrates a conventional laser machining apparatus including a machining head.

### REFERENCE SIGNS LIST

1: laser machining apparatus
2: workpiece
30: machining head
31: condenser lens
32: protection glass
34: torch
40: assist-gas feeding unit (cooling means)
45: assist gas (cooling gas)
50: exhausting unit (exhausting means)

### DESCRIPTION OF EMBODIMENTS

Referring to the attached FIGS., a laser machining apparatus 1 is described that is an embodiment of the present invention. The laser machining apparatus 1 emits the laser beam to the surface of a workpiece 2 and melts the surface of the workpiece 2, whereby laser beam machining such as laser cutting or laser welding is performed. The workpiece 2 is made of metal, e.g., aluminum or iron, and is supported movably with respect to the laser machining apparatus 1.

As illustrated in FIG. 1, the laser machining apparatus 1 includes a laser oscillator 10, an optical fiber 20, and a machining head 30.

The laser oscillator 10 generates a YAG (Yttrium Aluminum Garnet) laser beam (hereinafter simply called: laser beam) and outputs it. The laser oscillator 10 generates the laser beam with a predetermined output.

The optical fiber 20 is a transmitting path for the laser beam generated in the laser oscillator 10, and connects the output of the laser oscillator 10 to the base of the machining head 30. The laser beam is transmitted from the laser oscillator 10 to the machining head 30 through the optical fiber 20.

The machining head 30 of the laser machining apparatus 1 emits the laser beam and faces to the workpiece 2. The laser beam is applied to the surface of the workpiece 2 from the tip of the machining head 30.

The schematic way of machining the workpiece 2 by using the laser machining apparatus 1 is explained as follows. The laser beam generated by the laser oscillator 10 is transmitted through the optical fiber 20 to the machining head 30, and the machining head 30 emits the laser beam to the surface of the workpiece 2.

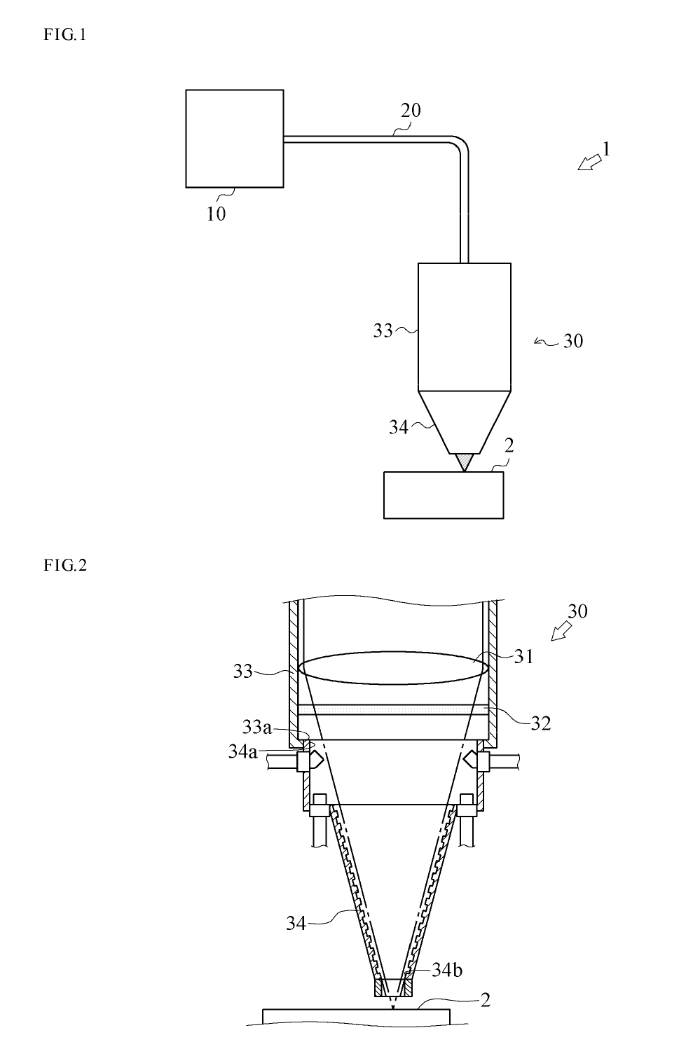

Referring to FIG. 2, the structure of the machining head 30 is described.

As depicted in FIG. 2, the machining head 30 contains a condenser lens 31, a protection glass 32, a lens housing 33 and a torch 34.

The condenser lens 31 is a convex lens to focus the laser beam to the surface of the workpiece 2 (machining spot) and to condense the energy thereof. The laser beam condensed through the condenser lens 31 is focused to the machining point of the workpiece 2.

The protection glass 32 is a plate glass to protect the condenser lens 31 from the foreign matters of high temperature such as spatters or fumes generated at the surface of the workpiece 2 during the machining or from grit and dust in the torch 34. The protection glass 32 is arranged between the condenser lens 31 and the workpiece 2. That is, the protection glass 32 is disposed at the side of workpiece 2 with respect to the condenser lens 31 so that the protection glass 32 divides the machining head 30 into two areas where the condenser lens 31 is disposed and the opposite side (where the torch 34 is disposed).

The laser beam passed through the condenser lens 31 is emitted to the workpiece 2 transmitting through the protection glass 32.

The lens housing 33 houses the optical systems including the condenser lens 31 and the protection glass 32, and has an opening 33a formed at the end thereof. The base end of the housing 33 is connected with the optical fiber 20, whereby the laser beam is emitted into the housing 33. The laser beam emitted into the housing 33 passes through the condenser lens 31 such that the laser beam is focused to the machining point of the workpiece 2, and is led into the torch 34 passing through the protecting lens 32 and the opening 33a.

The torch 34 is arranged continuously to the lens housing 33 and formed in a conical shape and tapered toward the tip. The torch 34 has an opening 34a formed at the base end corresponding to the opening 33a of the housing 33 and an emitting opening 34b formed at the tip end. The opening 34a of the torch 34 is connected to the opening 33a of the torch 34 and the inside of the torch 34 is communicated with that of the hosing 33. The laser beam led into the torch 34 through the housing 33 is emitted through the emitting opening 34b.

The torch 34 works as a housing which prevents the laser beam from dispersing and avoids the external influences on the laser beam.

As described above, in the machining head 30, the protection glass 32 is arranged between the condenser lens 31 and the torch 34, and the protection glass 32 protects the condenser lens 31 in such a way that the foreign matters such as spatters and fumes entering into the torch 34 do not reach the condenser lens.

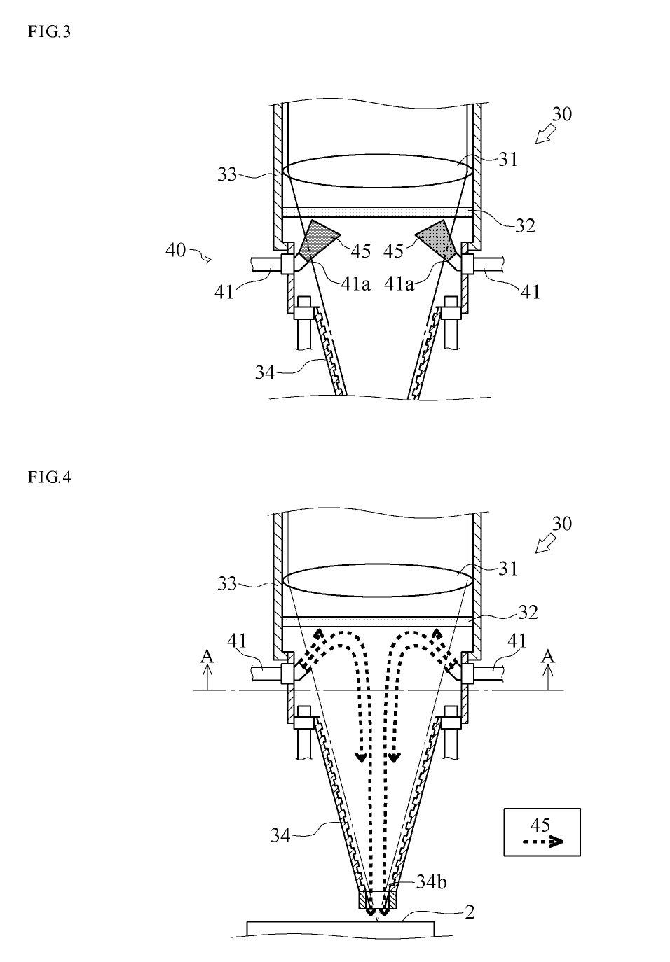

As shown in FIGS. 3 to 6, the machining head 30 contains an assist-gas feeding unit 40.

The assist-gas feeding unit 40 is a cooling means for feeding an assist gas 45 to the protection glass 32 during the laser machining is performed, and is arranged at the base end of the torch 34. In other words, the unit 40 blows the assist gas 45 to the tip side of the protection glass 32 (especially to the space defined by the protection glass 32 and the inside of the torch 34).

The assist gas 45 is an inert gas, which is used for prevention of the oxidation of the surface of the workpiece 2 and the penetration of the foreign matters into the machining point during the laser machining apparatus 1 performs the laser machining. For instance, the assist gas 45 is a nitrogen gas or an argon gas.

Blowing the assist gas 45 to the machining point in the workpiece 2 forms the inert atmosphere on the surface of the workpiece 2.

Moreover, the assist gas 45 is used at room temperature (about 25° C.), so that the assist gas works as the cooling gas for cooling the inside of the torch 34.

As shown in FIGS. 3 to 6, the assist-gas feeding unit 40 includes a single or multiple (in this embodiment, four) feeding pipes 41 and a feeding source 42 for feeding the assist gas.

Each feeding pipe 41 faces to the inside of the torch 34 through a blowing opening 41a, and is connected to the feeding source 42.

The feeding source 42 stores the assist gas 45 and feeds the assist gas 45 to the feeding pipes 41.

As depicted in FIG. 3, each blowing opening 41a of the feeding pipe 41 is arranged projecting toward the protection glass 32 from the inner wall of the torch 34. All of the blowing openings 41a are disposed outside of the focusing area of the laser beam.

More specifically, the feeding pipes 41 are arranged such that the assist gas 45 is evenly blown to the all area of the surface of the protection glass 32 and the assist gas 45 is blown to the center portion of the glass 32.

In other words, the assist gas 45 that is blown from the feeding pipes 41 to the protection glass 32 is blown around the center and gathered to the center on the surface of the glass 32. Thus, all area of the surface of the glass 32 is cooled by the forced convection heat transfer of the assist gas 45. Further, the assist gas 45 is continuously fed to the glass 32, so that the atmosphere around the glass 32 is kept in low temperature.

As described above, when the laser machining apparatus 1 performs the laser machining to the workpiece 2, the assist-gas feeding unit 40 blows the assist gas 45 of room temperature to the protection glass 32 through the feeding pipes 41, so that the surface of the glass 32 is forcedly cooled and the atmosphere around the glass 32 is also cooled. Furthermore, if the metal foreign matters of high temperature, e.g. spatters and fumes, enter into the torch 34 when performing the laser machining, the assist gas 45 blows and directly cools the foreign matters of high temperature.

Therefore, the foreign matters are cooled till they reach the protection glass 32 and the temperature of the foreign matters become lower than the melting point of the metal composing the foreign matters (e.g., 600° C.) or than the melting point of the glass (e.g., 400° C.). Especially, if the foreign matters are cooled enough and become solidified before they reach the glass 32, the foreign maters do not adhere to the glass 32.

As a result, the foreign matters are prevented from attaching to the glass 32 with their temperature are high and from penetrating (welding) into the glass 32, and thus the lifetime of the glass is improved and the transmittance of the glass 32 is maintained, thereby keeping the laser output.

The protection glass 32, which is easy to become high temperature when performing the laser machining, is directly cooled, so that the glass 32 avoids thermal expansion. Further, cooling the glass 32 that is arranged in the vicinity of the condenser lens 31 and the torch 34 makes the machining head 30 wholly cooled. Therefore, there are small thermal influences occurred in laser-machining such as the shift of focusing point caused by the thermal expansion of the condenser lens 31 or the change of the reflection index of the laser beam in the torch 34.

The laser machining apparatus 1 utilizes the assist gas 45 that is used for the purpose of good quality machining as the cooling gas for the protection glass 32, whereby there is no need to prepare the alternative cooling means and the existing equipment can be efficiently used.

As depicted in FIG. 4, the assist gas 45 blown to the protection glass 32 from each feeding pipes 41 is impinged on each other at the center of the glass 32, and then the blowing direction of the assist gas is changed the direction from the glass 32 to the emitting opening 34a of the torch 34. Thus, the assist gas 45 blown from the each pipe 41 is guided toward the workpiece 2 so that the machining point on the workpiece 2 is surrounded with the inert atmosphere.

As illustrated in FIG. 5, the number of the feeding pipes 41 is four, and the pipes are arranged with 90° apart on the circle of the torch 34. That is, the blowing openings 41a of the pipes 41 are equally spaced each other on the inner circumference of the torch 34.

Due to the structure, the assist gas 45 impinges equally on the protection glass 32, and the stable blowing is formed from the glass 32 to the emitting opening 34a of the torch 34. Therefore, when the assist gas 45 is used for cooling the protection glass 32, the assist gas 45 still provides the original performance so that the quality of laser machining of the laser machining apparatus 1 is maintained.

Furthermore, the assist gas 45 is blown from the multiple feeding pipes 41, and therefore the surface of the glass 32 is broadly cooled and the glass 32 and the peripheral atmosphere are efficiently cooled.

The arrangement of the feeding pipes 41 is not limited to this embodiment, in which the four pipes 41 are arranged in the circumferential direction of the torch 34 with 90° spaced each other. The feeding pipes may be arranged such that the assist gas from each pipe 41 is evenly impinged each other on the surface of the protection glass 32, and that the constant flow of the assist gas is formed from the glass 32 to the emitting opening 34a of the torch 34.

If the number of the feeding pipes 41 is increased, the blowing amounts from the pipes 41 are decreased. In view of cooling inside of the torch 34, the assist gas 45 should be blown to the protection glass 32 with the predetermined speed. There is a way to increase the blowing speed of the assist gas 45 by narrowing the blowing opening 41a of the pipe 41, however, in order to provide the original purpose of the assist gas 45, the blowing speed has to be set such that the oxygen existing around the openings 41a in the torch 34 is not mixed into the assist gas 45. Consequently, the number of the pipes 41 is set to satisfy these conditions.

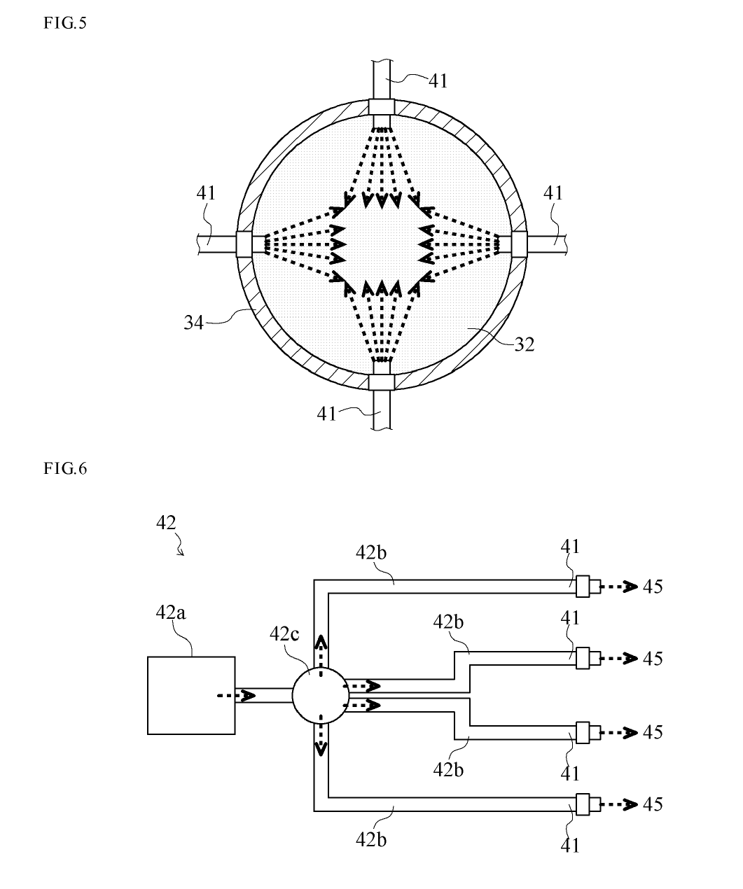

As shown in FIG. 6, the assist-gas source 42 includes a tank 42a storing the assist gas 45, multiple pipes 42b for feeding the assist gas from the tank, and a valve 42c for adjusting the flow amount of the assist gas fed through the pipes 42b.

In the assist-gas source 42, the assist gas 45 fed from the single tank 42a is equally divided into the multiple pipes 42b via the valve 42c, and finally fed to the feeding pipes 41. The assist gas 45 is led into the torch 34 through the blowing openings 41a of the feeding pipes 41 and blown to the machining point of the workpiece 2 passing through the emitting opening 34b of the torch 34.

In the valve 42c, the flow amount of the assist gas 45 fed to the each pipe 42b is detected with a flow sensor so that the flow amounts of the assist gas 45 passing through the pipes 42b are even. That is, the flow amount of the assist gas 45 blown through the each feeding pipe 41 is constant.

It should be noted that the flow amount of the assist gas 45 fed from the assist-gas source 42 is adjustable in accordance with the machining condition of the workpiece 2 (laser welding, laser cutting and the like).

In this embodiment, from the viewpoints of preventing the facility from becoming large or complex and of making the best of existing facility, the single gas tank 42a provides the assist gas 45 with the each feeding pipe 41 via the valve 42c and the pipes 42b. However, each feeding pipe 41 may be provided with the tank 42a, the pipe 42b and the valve 42c, in this case, the flow condition (pressure, flow amount or the like) of the assist gas 45 blown through the each feeding pipe 41 is easily adjusted.

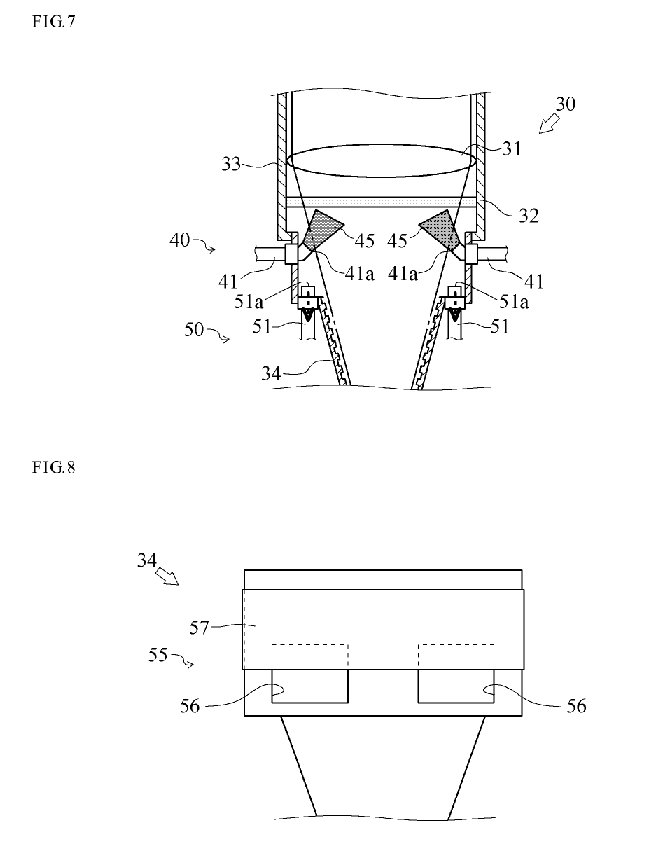

As illustrated in FIG. 7, the machining head 30 further includes an exhausting unit 50.

The exhausting unit 50 is an exhausting means for exhausting the atmosphere (involving a part of assist gas 45 reflected on the protection glass 32 and a part of the foreign matter of high temperature) in the torch 34 to the outside of the machining head 30 during the laser machining. The exhausting unit is disposed in the middle portion of the torch 34.

The exhausting unit 50 includes single or multiple (in this embodiment, four) suction pipes 51, a suction pump and an adjusting valve (both not shown).

The suction pipes 51 have inner ends facing inside of the torch 34 via suction ports 51a, and the outer ends are connected to the suction pump.

The suction pump sucks and exhausts the atmosphere in the torch 34 through the suction ports 51a of the suction pipes 51. The suction pump is connected to the suction pipes 51 via the adjusting valve, and the adjusting valve adjusts the suction amount by the suction pump.

As shown in FIG. 7, the suction ports 51a of the suction pipes 51 are arranged in the middle portion of the torch 34, and arranged in the nearer side to the emitting opening 34b of the torch 34 than the blowing openings 41a of the feeding pipes 41. The suction ports 51a are disposed outside of the focusing area of the laser beam.

Through the suction pipes 51, the atmosphere in the torch 34 is sucked. That is, the part of the assist gas 45 and the part of the foreign matters (especially, the fumes) entered into the torch 34 are sucked through the suction pipes.

The suction pump is a metering pump and creates a negative pressure in the suction pipes 51 to draw the atmosphere in the torch 34 through the suction ports 51a. The adjusting valve is disposed between the suction pipes 51 and the suction pump.

The adjusting valve is a variable valve to adjust the suction amount by the suction pump. That is, the exhausting amount of the atmosphere to the outside of the torch 34 is controlled by the adjusting valve.

Further, in the adjusting valve, the flow amounts sucked through the suction pipes 51 are detected by sensors so that the pressure in the torch 34 is constant, namely the flow amount of the assist gas 45 is constant that is fed to the machining point of the workpiece 2 through the emitting opening 34b of the torch 34.

As described above, when the laser machining apparatus 1 performs the laser machining to the workpiece 2, the exhausting unit 50 exhausts the atmosphere in the torch 34 to the outside of the torch 34, the atmosphere involving the assist gas 45 and the foreign matters of high temperature.

Thus, the torch 34 avoids being high pressure because of the excessive feeding of the assist gas 45 from the assist-gas feeding unit 40. So, even if the assist gas 45 is used for a coolant, the cooling performances for the protection glass 32 and the inside of the torch 34 are maintained, and the original performance as the generator of the inert atmosphere of the assist gas 45 is secured. Also, exhausting the atmosphere in the torch 34 that is easy to be high temperature during the laser machining makes the cooling performance in the torch 34 improved.

Moreover, the flow (feeding) amount of the assist-gas feeding unit 40 and the suction (exhausting) amount of the exhausting unit 50 are separately controlled. So, the best mode of feeding the assist gas 45 is achieved, thereby obtaining the good quality of the laser machining.

The exhausting means for exhausting the atmosphere in the torch 34 is not limited to the above-described embodiment. For example, FIG. 8 depicts the alternative embodiment, in which the torch 34 has an exhausting unit 55 including a single or multiple windows 56 for communicating the inside to the outside of the torch 34 and shutters 57 for adjusting the opening areas of the windows 56.

In such embodiment, when the inside of the torch 34 becomes high pressure due to the feeding of the assist gas 45, the inside and the outside of the torch 34 are communicated through the windows 56 so that the atmosphere in the torch 34 is exhausted to the outside with the differential pressure. Through the windows 56 with the opening areas adjusted by the shutters 57, the atmosphere in the torch 34 is communicated to the outside, so that the adjusted amount of atmosphere in the torch 34 is exhausted outside of the torch 34. Thus, the exhausting unit 55 has the same effect as the exhausting unit 50 does, and further obtains an additional effect that there is no need to prepare the suction means, which reduces costs.

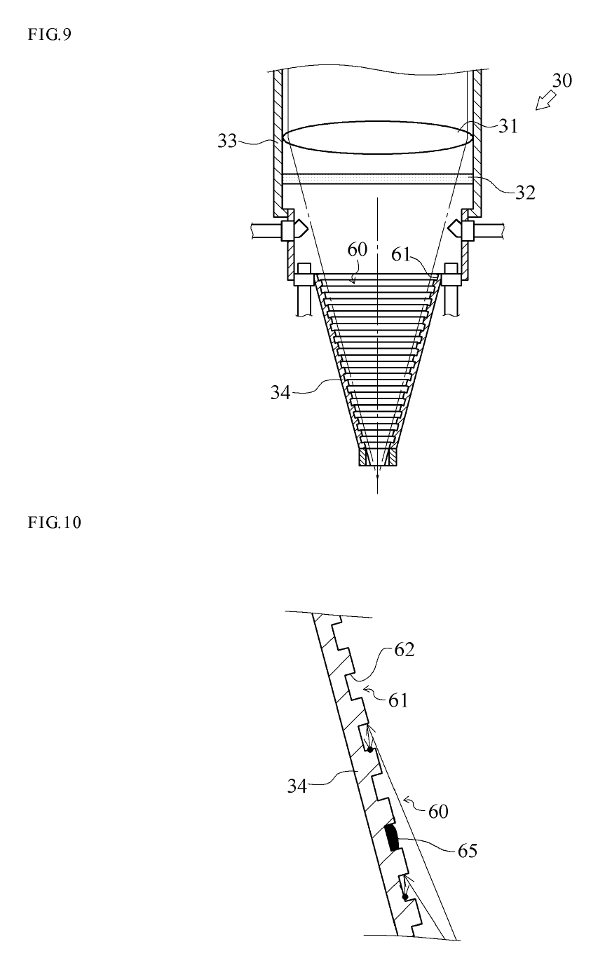

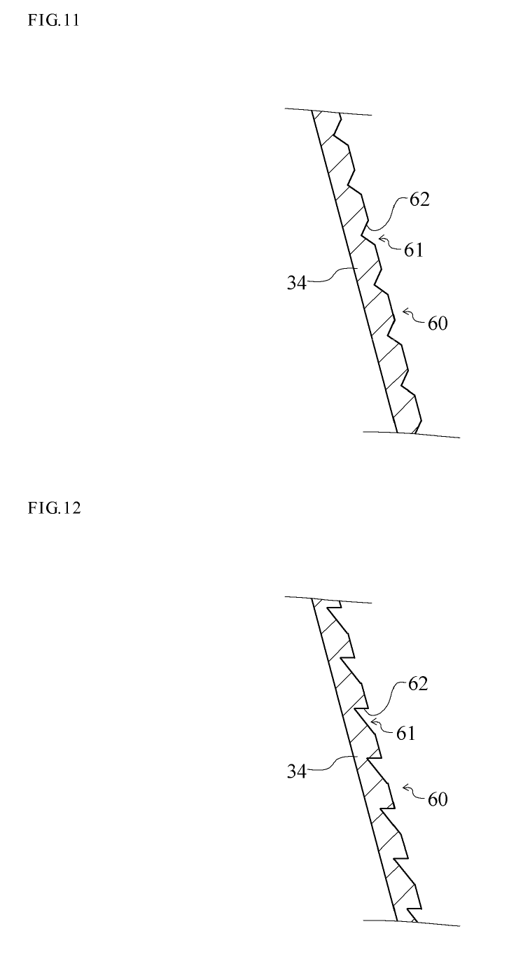

As depicted in FIGS. 9 and 10, the torch 34 has an inner surface 60 formed with grooves 61 that are configured continuously from the base end to the tip end thereof, and the inner surface 60 has a multi-step surface by the grooves 61.

The inner surface 60 defines the inside space of the conical torch 34, and the distance between the laser beam passing through the torch 34 and the surface is set larger than a predetermined length (e.g., preventing the laser beam from dispersing and from being affected by the disturbance).

The grooves 61 are formed on the inner surface 60 continuously in the axis direction of the torch. The grooves 61 are coved portions forming the multi-step surface on the inner surface 60, and the multi-step configuration reflects the foreign matters entering into the torch 34 through the emitting opening 34b toward the direction except toward the protection glass 32.

In other words, due to the configuration of the grooves 61 on the inner surface 60 of the torch 34, the foreign matters hitting the inner surface 60 reflect diffusely on the grooves 61, thereby reducing the arrival rate to the protection glass 32.

As depicted in FIG. 9, the grooves 61 are formed in the circumferential direction in the inner surface 60 around the axis of the torch 34 and continuously in the axis direction.

FIG. 10 shows that the grooves 61 are formed as recesses depressed inside from the inner surface 60 toward the outside of the torch 34. In detail, the groove 61 has a reflection face 62 that is perpendicular to the inner surface and facing the machining point of the workpiece 2. When the foreign matters such as the spatters flown from the machining point of the workpiece 2 hit and reflect on the reflection face 62, the foreign matters reflect toward the direction except toward the protection glass 32 (such that the foreign matters do not reach the glass 32 with one reflection on the inner surface 60).

That is, the grooves 61 formed in the inner surface 60 of the torch 34 prevent the foreign matters scattered over from the machining point of the workpiece 2 in the laser-machining from reflecting toward the protection glass 32 on the inner surface 60, and each of which has the reflection face 62 that has a plane where the incident angle of the radial line from the machining point of the workpiece 2 is more than a predetermined angle (the reflected line of the incident line does not direct the protection glass 32).

As described above, the inner surface 60 of the torch 34 has the grooves 61 formed continuously from the base end to the tip end. Each groove 61 reflects the foreign matters of high temperature that is scattered from the machining point of the workpiece 2 toward the direction except toward the protection glass 32.

When the foreign matters enter into the torch 34 through the emitting opening 34b and hit the groove 61 of the inner surface 60, the foreign matters reflect toward the other direction than toward the protection glass 32, thereby lowering the possibility for the foreign matters to reach the protection glass 32. Moreover, if the foreign matters reflect in the groove 61 in plural times until they reach the protection glass 32, the temperature of the foreign matters is lowered in response to the reflection number and accelerated to become solidified, thereby prevented from adhering to the protection glass 32.

Therefore, the protection glass 32 is prevented from adhesion and penetration of the foreign matters of high temperature, and the protection glass 32 keeps its transmittance, thereby increasing the life thereof. Especially, the present embodiment provides the unexpected effect compared with the conventional structure that has a flat inner surface (60).

The foreign matters of high temperature reflect in the groove 61 in plural times, and are solidified in the recess of the groove 61 with anchor effect, whereby the foreign matters are collected in the groove 61 as a deposition 65, which is spread in the groove. In this case, the grooves 61 are formed to be depressed toward the outside from inside of the inner surface 60, so that the deposition 65 collected in the groove 61 is not likely to contact the laser beam traveling in the torch 34.

The deposition 65 accumulated in the inner surface 60 of the torch 34 (the groove 61) is not likely to block the laser beam, thereby keeping the laser output.

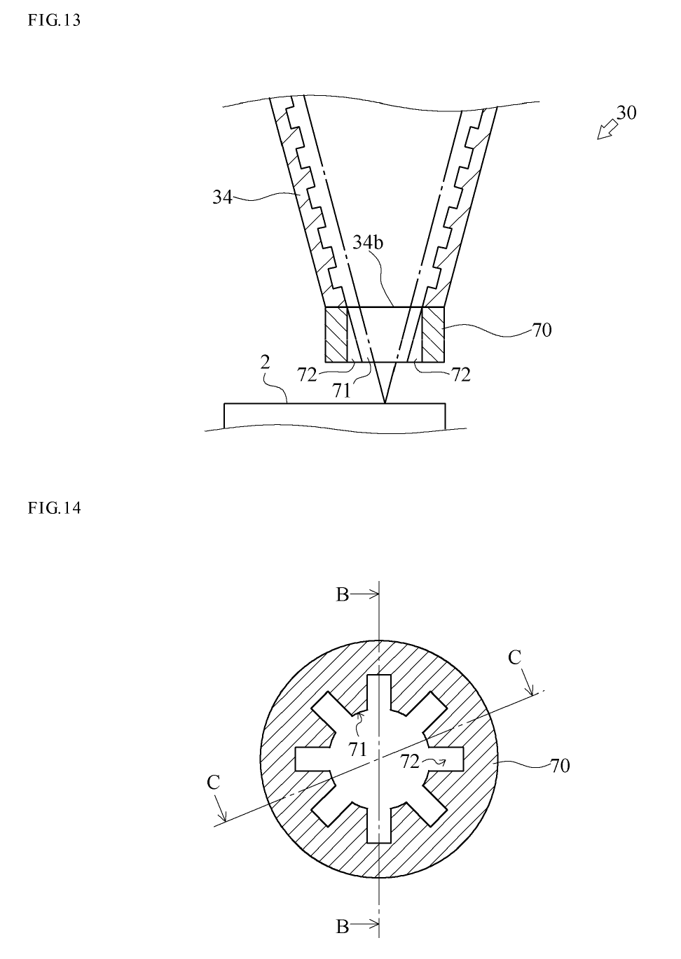

The grooves 61 may be configured having triangle groove profile, shown in FIG. 11, or sawtooth groove profile, shown in FIG. 12. In both configurations, at least the face opposing to the machining point of the workpiece 2 is configured as the reflection face 62, which has the plane where the incident angle of the radial line from the machining point is set in the above-described manner.

Additionally, as long as it goes to the base from the tip in the inner surface 60, the groove 61 may become deeper or the reflection face 62 of the grove 61 may be inclined larger toward the tip. Due to such structures, the incident angles of the foreign matters scattered from the machining point of the workpiece 2 against the grooves 61 disposed at the base side can be adjusted properly.

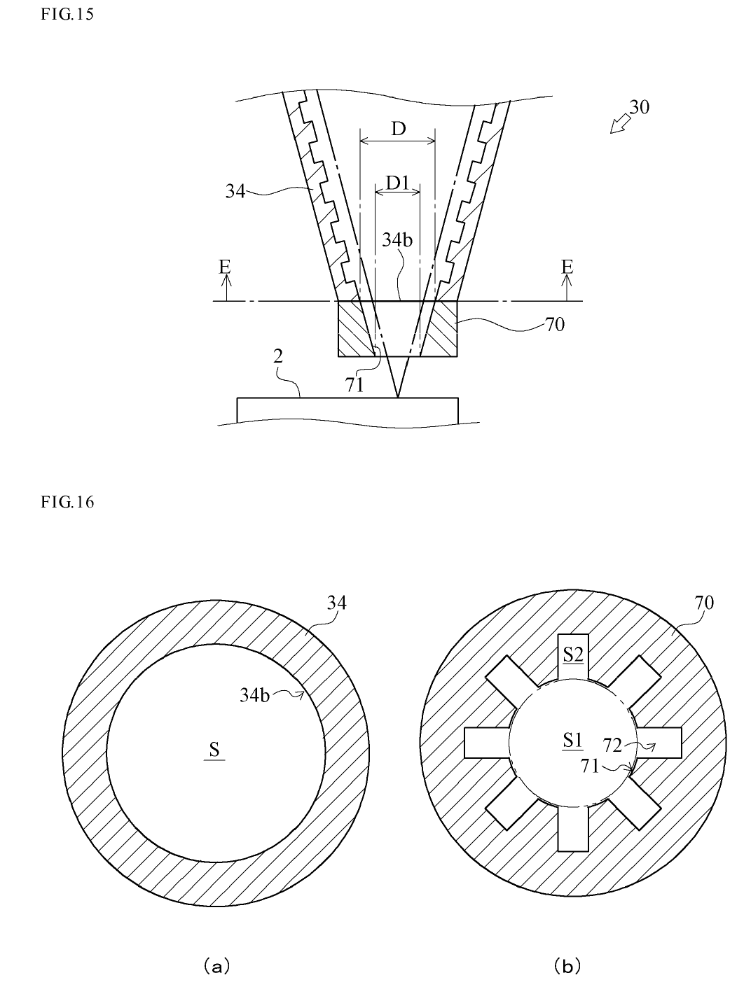

As shown in FIGS. 13 to 15, the torch 34 has a tip 70.

The tip 70 is attached to the tip end of the torch 34 to extend toward the workpiece 2. The tip 70 is made of a material composed of Molybdenum or a material of heat resistance and of durable, and separated from the torch 34.

In other words, the torch 34 has the tip 70 at the tip end thereof, so that the distance between the torch 34 and the workpiece 2 becomes shorter, and thereby there is a smaller area of the opening of the torch 34 through which the foreign matters of high temperature generated at the machining point of the workpiece 2 enter. Thus, the foreign matters scattered over from the machining point of the workpiece 2 are prevented from entering into the torch 34.

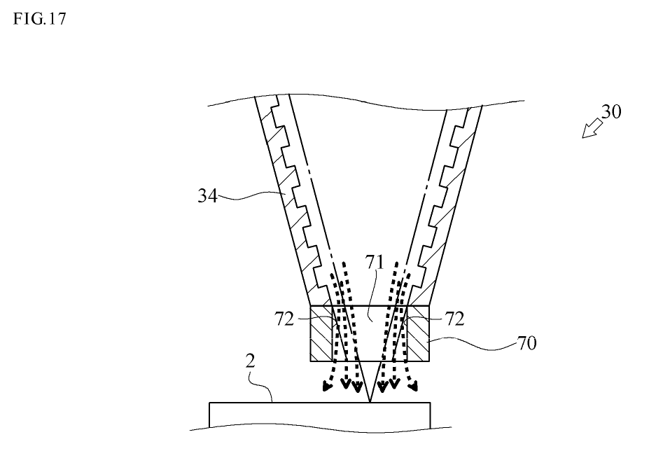

As shown in FIGS. 14 and 15, the tip 70 includes an opening 71 formed with an inner surface continued from the inner surface of the torch 34 and an assist-gas passage 72 formed as a slit extended outwardly from the periphery of the opening 71.

The extended length of the tip 70 from the torch 34, namely the clearance between the tip end of the tip 70 and the machining point of the workpiece 2, is set in response to the influence of the melting heat of the laser machining, the entrance rate of the foreign temperature, and the blowing speed of the assist gas 45. In this embodiment, the extended length of the tip 70 is set in the minimum length satisfying the above-mentioned conditions.

As illustrated in FIG. 15, the inner surface of the opening 71 is tapered from the base end to the tip end as the torch 34 is. The inner diameter D1 of the opening 71 is set in response to the outer diameter of the laser beam (the minimum diameter which provides the clearance between the opening and the laser beam), and set smaller than the inner diameter D of the emitting opening 34b of the torch 34. Thus, without interrupting the laser beam, the opening of the machining head 30 is formed in a small area.

As illustrated in FIG. 16, the total area of the area S1 of the opening 71 and the area S2 of the assist-gas passage 72 is smaller than the opening area S of the emitting opening 34b of the torch 34.

As depicted in FIG. 14, the assist-gas passages 72 are formed as slit grooves, which are cut radially from the inner periphery of the opening 71. The bottom of the assist-gas passage 72 has the same diameter as the emitting opening 34b of the torch 34 does.

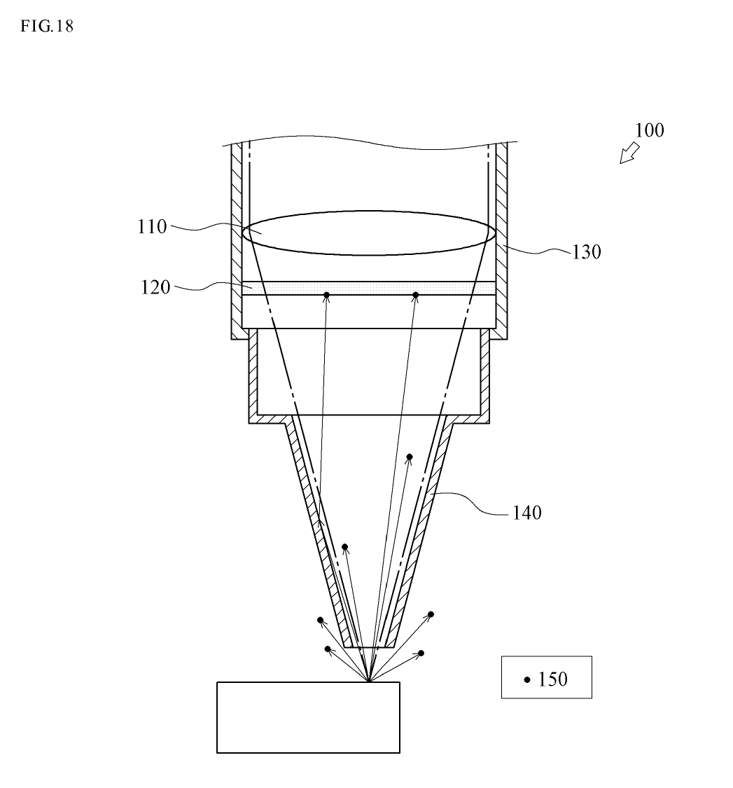

The assist-gas passage 72 includes the inner surface continued from the inner surface of the torch 34. As illustrated in FIG. 17, the assist gas 45 flows along the inner surface of the torch 34 and that of the assist-gas passages 72 according to the flow characteristics, and thereby the machining point of the workpiece 2 is surrounded with the inert atmosphere.

As described above, at the tip end of the torch 34, the tip 70 is attached extending the tip end. The tip 70 includes the opening 71 having the inner diameter D1 corresponding to the outer diameter of the laser beam traveling through the torch 34 and the assist-gas passages 72 opening outward from the outer periphery of the opening 71.

Due to the above-described structure, the opening area of the tip 70 is set smaller than the opening area of the opening 34a of the torch 34, and thereby the foreign matters of high temperature are physically prevented from entering into the torch 34 through the tip 70.

Therefore, the adhesion of the foreign matters to the protection glass 32 is prevented, and the penetration of the foreign matters into the protection glass 32 is avoided. As a result, the transmittance of the protection glass 32 is maintained, and the useful life of thereof is increased. Especially, the present embodiment obtains a noticeable effect compared with the conventional structure in which the opening area is large with respect to the entering opening of the foreign matters.

The tip 70 provides the short clearance between the machining head 30 and the machining point of the workpiece 2, so that the conditions of the assist gas 45 such as flowing speed should be considered. In this embodiment, the tip includes the assist-gas passages 72 having the inner surface continued from the inner surface of the torch 34.

The assist gas 45 blowing along the inner surface of the torch 34 flows along the assist-gas passages 72 in the tip 70. In short, the assist-gas passages 72 function as the flow passages for the assist gas 45. Further, the opening area of the tip 70 is enlarged by the assist-gas passages, whereby the passage of the assist gas 45 is enlarged.

Therefore, the concentration of the assist gas 45 on the machining point of the workpiece 2 is prevented, so that the increase of blowing speed of the assist gas 45 through the tip 70 is prevented.

Additionally, the tip 70 is a separated member from the torch 34.

Thus, there are advantages in selection of the best material for the tip 70 and in machining accuracy for the inner surface of the tip 70 (especially, in the configurations of the opening 71 and the assist-gas passages 72). Moreover, the tip 70 is easily applicable to the conventional laser machining apparatus.

In this embodiment, the assist-gas passages 72 are formed in the axis direction of the torch 34 and the number of the passages is eight. The assist-gas passages may be formed in alternative configurations such that they have a predetermined passage area and avoid the blocking of the assist gas 45.

The tip end of the opening 71 may be enlarged from the inner periphery of the opening 71 toward the outside of the tip 70. In this embodiment, the flowing condition of the assist gas 45 is improved.

### INDUSTRIAL APPLICABILITY

The present invention is applicable to a laser machining apparatus for welding or cutting a workpiece, especially to a technique of protecting a protection glass composing a part of optical systems of the laser machining apparatus.

1. A laser machining apparatus emitting a laser beam to a surface of a workpiece and melting the surface of the workpiece, thereby performing a laser beam machining, comprising:
a condenser lens for focusing the laser beam to the surface of the workpiece;
a protection glass disposed nearer to the workpiece than to the condenser lens, protecting the condenser lens;
a torch disposed facing the workpiece, emitting the laser beam; and
cooling means for cooling the protection glass.

2. The laser machining apparatus according to claim 1,
wherein the cooling means blows a cooling gas to the protection glass to cool the protection glass and the atmosphere in the torch.

3. The laser machining apparatus according to claim 2,
wherein the cooling gas is an assist gas blown to the surface of the workpiece in the laser machining to form an inert atmosphere around the surface of the workpiece.

4. The laser machining apparatus according to claim 3,
wherein the cooling means comprises multiple openings for blowing the assist gas, and
wherein the assist gas is blown to the surface of the protection glass from the blowing openings.

5. The laser machining apparatus according to claim 4,
wherein the multiple openings are disposed facing the inside of the torch and spaced each other in the inner circumference of the torch.

6. The laser machining apparatus according to any one of claims 1 to 5, further comprising:
an exhausting means for exhausting the atmosphere in the torch to the outside thereof.

7. The laser machining apparatus according to claim 6,
wherein the exhausting means comprises an exhausting opening through which the atmosphere in the torch is exhausted, and adjusting means for adjusting the flow amount of the atmosphere to be exhausted.

8. The laser machining apparatus according to any one of claims 1 to 7,
wherein the inner surface of the torch is formed in a multi-step surface.

9. The laser machining apparatus according to claim 8,
wherein the multi-step surface comprises a face opposing to the surface of the workpiece, and
wherein the face opposing to the surface of the workpiece is formed such that a line reflected on the face, that is a radially incident line from the surface of the workpiece, does not direct the protection glass.

10. The laser machining apparatus according to claim 8 or 9,
wherein the multi-step surface of the torch is configured by multiple grooves formed depressed from the inner surface to the outer surface of the torch and formed continuously from the base end to the tip end of the torch.

11. The laser machining apparatus according to one of any claims 1 to 10,
wherein the tip end of the torch is provided with a tip extended toward the surface of the workpiece, and
wherein the opening area of the tip is set smaller than that of the torch.

12. The laser machining apparatus according to claim 11,
wherein the inner surface of the tip is configured continuously from the inner surface of the torch.

13. The laser machining apparatus according to claim 11 or 12,
wherein the tip is separated from the torch.
